(19) United States
(12) Patent Application Publication
(10) Pub. No.: US 2004/0179764 A1
(43) Pub. Date: Sep. 16, 2004

(54) Interferometric analog optical modulator for single mode fibers

(76) Inventors: Noureddine Melikechi, Dover, DE (US); Kamel Amara, Dover, DE (US); William D. Jamison, Easton, PA (US)

Correspondence Address: RATNERPRESTIA, P.O. BOX 1596, WILMINGTON, DE, 19899, US

(21) Appl. No.: 10/678,367

(22) Filed: Oct. 3, 2003

Related U.S. Application Data
(60) Provisional application No. 60/454,990, filed on Mar. 14, 2003.
(60) Provisional application No. 60/472,968, filed on May 23, 2003.

(51) Int. Cl. G02F 1/01

(52) U.S. Cl. 385/1; 385/39

(57) ABSTRACT

A device for simultaneously coupling and modulating incident radiation to a single mode optical fiber based on a solid state truncated integrated Mach-Zehnder interferometer having a back end formed by two converging radiation channels converging at an angle θ and terminating prior to overlapping. The angle θ is calculated to produce in an interference zone formed by the exiting radiation a primary constructive interference fringe that provides an optimum match to an input fiber mode of a fiber positioned within the interference zone. Phase shifting elements in the radiation propagation paths provide a linear shift of the constructive interference fringe across the input of the fiber optic in response to an analog signal.

### CROSS REFERENCE TO RELATED APPLICATIONS

This application claims the benefit of priority to U.S. Provisional Application No. 60/454,990, filed on Mar. 14, 2003, and Application No. 60/472,968, filed on May 23, 2003, both the contents of which are incorporated herein by reference in their entirety.

This application is also related to United States application filed concurrently herewith entitled “OPTICAL COUPLING DEVICE FOR SINGLE MODE OPTICAL FIBERS” Amara et al., Ser. No. unknown.

### FIELD OF THE INVENTION

This invention relates to apparatus and associated method for simultaneously coupling and modulating the output of an optical radiation source to a single mode optical fiber or optical wave-guide and more particularly to apparatus and associated method employing a solid state truncated Mach-Zehnder integrated interferometer to generate and laterally shift an interference pattern across a detector input face.

### BACKGROUND OF THE INVENTION

In recent years, fiber-optic cables have been increasingly used for communications, particularly in telephone and cable TV systems. Currently it is possible to manufacture long, continuous strands of optical fiber, which may propagate signals without substantial attenuation over long distances. It is also possible to manufacture the fiber structure as an optical wave-guide wherein only preselected modes of light propagate in the fiber. By limiting wave propagation through the fiber to a single mode, the bandwidth of the optical fiber may be exceedingly high to provide a high information-transfer capacity without signal dispersion related problems. Moreover, optical-fiber transmission equipment is compact, lightweight, and potentially inexpensive. Transmission over optical fibers does not generate interference and is unaffected by external interference.

Typically, a long haul and/or high bandwidth signal transmission system employing fiber optics, includes a light source such as a laser diode or an LED, and a photo detector such as a photodiode, connected through a single mode fiber-optic or optical wave-guide cable. Information is typically transmitted in digital form, as a series of light pulses that form a bit stream or in analog form wherein the amplitude of the transmitted beam is varied in a continuous manner.

While transmitting information over optical fibers or wave-guides has numerous advantages, information transmission through fibers and their component waveguides suffers from laser-light launching losses into single mode fibers and wave-guide channels whose cross sectional dimensions are in micron range. Typical coupling efficiencies are about 50%. This necessitates using higher power, and therefore cost laser sources and/or using a large number of expensive and cumbersome optical amplification systems including additional pump lasers, Erbium Doped fibers, couplers, gain flattener, optical filters, polarization controllers to compensate for the losses due to the low coupling efficiency.

The introduction of a modulator between the source and transmitting fiber or waveguide introduces two more coupling surfaces and further decreases the efficiency of energy transfer from the source to a detector.

The simplest coupling system involves bringing the output end of a radiation source in butting engagement with the input end of the receptor. The radiation source may be a laser, an output end of a single mode fiber, a waveguide output etc. If the source is a laser it is possible to amplitude modulate the laser directly without introducing additional coupling losses. This, however is not always possible, and external modulators that modulate the carrier beam after it has been emitted from the laser are commonly used in optical communication systems. Such systems require coupling the modulator output to the detector.

Butt coupling suffers considerably from the fiber core-cladding eccentricity and is effective only in permanent junctions. The more customary coupling method involving focusing the output of the radiation source, typically a laser, onto the input of the receptor fiber using a focusing lens is limited in that the focused radiation spot is diffraction limited. In practice the minimum spot size that can be achieved due to the difficulty in obtaining an ideal Gaussian spot is larger than the diffraction limited spot. When such coupling is employed to couple a laser source to a single mode fiber having typical core diameter of 3-9 microns, the coupling efficiency drops to about 55%.

It has also been shown that the use of an interferometer can enhance the coupling efficiency in a quasi-phase-matched second harmonic generation process in a 4 μm wide titanium phosphate waveguide by as much as 61%. (Effects of interference in quasiphase-matched periodically segmented potassium titanyl phosphate waveguides, Zachary S. Benaich et al. Applied physics letters, Volume 75, Number 21, Nov. 22, 1999, incorporated herein by reference). The disclosed technique involves passing the fundamental beam through half waveplates and beam splitter cube combination that allows the variation of the power ratio of the two beams and individually coupling each beam into the wave guide using a lens. While this method may be implemented in a laboratory, it suffers in that it is extremely sensitive to vibration and therefore impractical for commercial applications.

Recently a number of optical modulator schemes have been proposed that utilize an integrated Mach-Zehnder interferometer with a phase retardant element in at least one leg to produce an optical wave phase shift. In particular U.S. Pat. No. 6,587,604 issued on Jul. 1, 2003 claiming foreign priority of Sep. 29, 2000 shows the use of an integrated Mach-Zehnder interferometer but coupled to a wave guide used as a modulator. This arrangement, however, still lacks in the efficient coupling between the modulator and the transmitter path for the modulated source, i.e. the optical fiber or the optical waveguide.

There is thus still a need for an efficient coupler for modulating and coupling a radiation source to the input of a receptor single mode fiber or optical wave-guide, that is practical, reliable and easy to implement.

### SUMMARY OF THE INVENTION

There is, therefore, provided in accordance with the present invention an integral solid state radiation modulator and coupler comprising a radiation input end and a radiation output end said radiation input end connected to said radiation output end through two diverging and two converging radiation paths wherein said radiation paths converge to said output end at an angle 2θ. θ is an interference angle calculated to produce an exiting radiation interference pattern of radiation entering the input end at an interference zone outside the output end. The interference pattern forms a primary constructive interference fringe whose mode is adapted to maximize energy transfer efficiency from the entering beam to a radiation receiver input end positioned in the interference zone by matching the constructive interference spatial mode to the radiation receiver input end mode. As used herein the term matching indicates a best match rather than an absolute match. At least one of the two radiation paths includes a phase shifting device whereby the phase of the traveling radiation may be shifted relative to the phase of the radiation traveling along the other path.

The phase shift introduced linearly shifts the primary interference fringe laterally across the input face of the single mode fiber or waveguide. As a result the amount of energy transfer to the single mode fiber input varies in a controlled way from a maximum to zero, providing an effective and efficient way to modulate and couple in a single step the source output to the signal transmitting fiber path. An external driver is preferably included to control the degree of phase shifting applied and the resulting shifting of the constructive interference fringe across the face of a detector positioned within the interference zone, to increase or decrease the amount of energy incident on a detector input face and thereby modulate the beam energy amplitude received by the detector.

The optical radiation source may be integral with the coupler/modulator input end. The device may further comprise a fiber or wave guide holding attachment for holding a fiber or waveguide fixedly in the interference zone, such as a clamp. Alternatively, the optical fiber or waveguide may be glued, soldered or clamped in place. The fiber or waveguide includes an input surface and such input surface lies in a plane substantially perpendicular to the solid state device radiation propagation axis.

Still according to this invention there is provided a solid state system comprising:

A. a radiation source;

B. a solid state radiation coupler comprising a radiation input end adapted to receive an output of said radiation source and a radiation output end, the coupler having a central axis extending along a “z” axis of a Cartesian co-ordinate system, the coupler further comprising:

i. an input radiation beam splitter comprising first and a second equidistant diverging solid state radiation propagation channels extending from said coupler input each of said channels having a first and a second length respectively;

ii. a third and a fourth also solid state equidistant converging radiation propagation channels connected to said first and second diverging channels respectively, each of said third and fourth channels having a third and a fourth length respectively, each of said third and fourth channels converging toward said z axis at an interference angle “θ” relative to said axis and wherein said third and fourth channels terminate without overlap at the beginning of, or prior to a radiation interference zone where radiation exiting said third and fourth channels generates an interference pattern, said zone extending by a distance Lᵢₙₜ/2 from a point on said z axis where a center line of a beam propagating along said third channel and a beam propagating along said fourth channel intersect;

iii. a phase control element in one of said channels;

C. an electronic modulator connected to said control element; and

D. a radiation receptor having an input surface located within said interference zone.

Associated with this apparatus there is also a method of maximizing energy transfer between an optical radiation source and a desired radiation receptor while simultaneously amplitude modulating the radiation. The receptor may be a single mode optical fiber or an optical waveguide. Such method comprises splitting the optical radiation into two substantially equal intensity beams traveling along two distinct solid state paths and recombining the two beams onto the input surface of the receptor single mode fiber after applying a controlled phase delay to at least one of the two beams. The beams are recombined by directing the beams onto the input surface at an angle relative to each other calculated to generate a constructive spatial interference mode within an interference zone that maximizes optical field amplitude transfer to the receptor by optimal matching of the constructive interference spatial mode to the receptor input mode. The degree of phase shifting controls the lateral position of the constructive interference fringe relative to the receptor input, thereby controlling the amount of energy incident thereon.

### BRIEF DESCRIPTION OF THE DRAWINGS

FIG. 1 is a schematic representation of a basic integral optical coupler/modulator in accordance with the present invention.

FIG. 1A is a schematic representation of the interference pattern generated at the output of the coupler superposed on the input surface of a single mode fiber positioned in the x-y plane in the interference zone.

FIG. 1B is an enlarged schematic representation of the area within the circle in FIG. 1 illustrating the output end of the coupler/modulator and relative positioning of the single mode fiber input end in greater detail.

FIG. 2 is a schematic representation of an alternate embodiment of the invention comprising an integral radiation source formed at the input end of the coupler/modulator, parallel beam paths connecting the diverging and converging channels and phase delay devices in both parallel channels.

FIG. 3 is a schematic representation of the lateral shifting of the primary interference fringe as a result of a phase delay in one of the interfering beams.

### DETAILED DESCRIPTION OF THE INVENTION

The invention will next be described with reference to the figures wherein same numerals are used to identify same elements in all figures. The figures illustrate the invention and are not intended to act as engineering or construction drawings, therefore they are not to scale and do not include all elements that may be included in such drawings, as inclusion of such elements would unduly clutter the drawings. The invention will also be described with specific reference to the use of a single mode fiber (SMF) but the invention is similarly applicable for coupling an optical wave-guide to a radiation source or to another wave-guide.

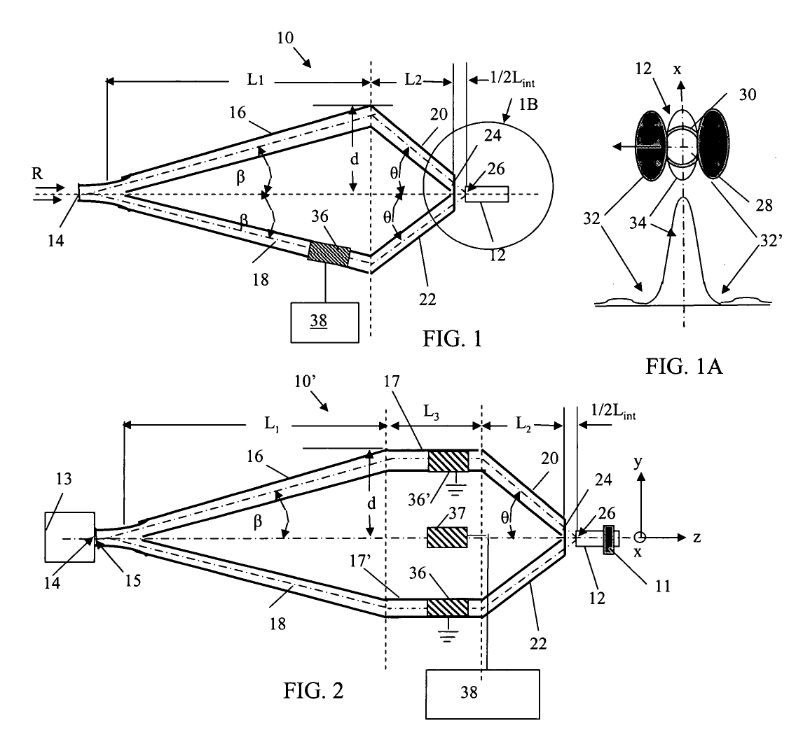

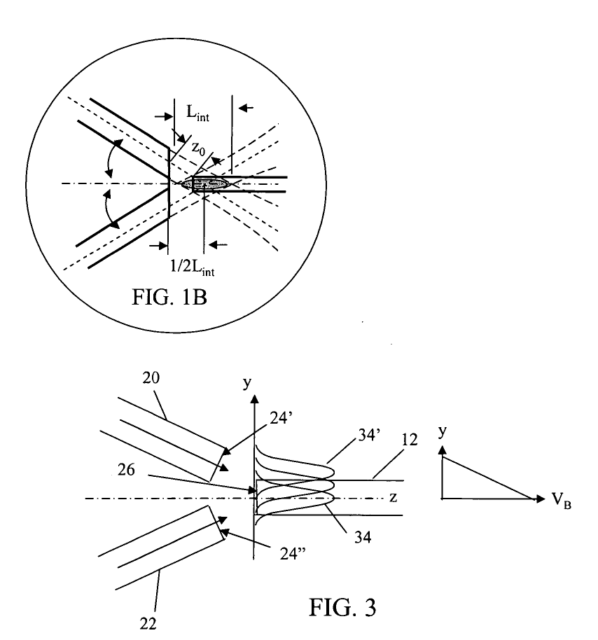

Referring next to FIG. 1 there is shown a solid state interferometer based coupler/modulator 10 for connecting a single mode fiber 12 to input radiation R and for modulating the radiation R. The coupler comprises a front end section that includes an input 14 followed by a Y-junction divider having a first channel 16 and a second channel 18. Preferably the Y-junction divider is a 3 dB splitter that splits the input radiation into two equal energy beams that propagate along channels 16 and 18.

FIG. 2 illustrates an alternate embodiment where following the splitting of the input radiation along two diverging channels 16 and 18, the radiation propagates along two substantially parallel channels 17 and 17′ as in a typical integrated Mach-Zehnder interferometer.

An integrated Mach-Zehnder interferometer is a well known device that consists of an input “Y” junction which causes the light propagating in a single channel wave guide to be split into two channel waveguides. At some distance from this input junction a simple bend is incorporated in both channels to cause the channels to become parallel to one another. Light then propagates in parallel straight sections of channel waveguides until it reaches a beam combining section. The beam combining section is the reverse of the beam splitting section; that is, parallel channels encounter simple bends which direct the two channels into the two waveguide end of a second “Y” junction. Light emerges from this output Y-junction in a single-channel waveguide. Typically, the paths along two channels are not identical in length thereby introducing a phase difference between the two recombining beams and producing an interference pattern following recombination at the output “Y” junction. It is common practice in using an integrated Mach-Zehnder interferometer to enhance this effect by introducing a phase delay element in one or both of the two parallel channels and control the degree of phase shift between the two interfering beams.

The solid state interferometer based coupler according to this invention differs from the typical integrated Mach-Zehnder interferometer described above in the structure of the output section. As illustrated in FIG. 1, the back end of the coupler also includes two converging channels 20 and 22. Channels 20 and 22 are connected to channels 16 and 18 respectively, either directly or, as shown in FIG. 2, through parallel channels 17 and 17′, and the four channels together provide two continuous radiation propagation paths between the coupler input 14 and output 24. However, according to the present invention, the two converging channels 20 and 22 do not form a “Y” junction terminating to a single output channel.

For ease of description we will refer to a preferred embodiment arrangement wherein the radiation propagation channels are all in a single plane. A particular Cartesian coordinate axis system “xyz” shown in FIG. 2, is used for ease of understanding the relationship between the parts of this device. The radiation. propagates in the direction of the “z” axis and the coupler contains a propagation axis along the “z” axis. Diverging and converging angles are angles in the y-z plane relative to the propagation axis “z” and substantially parallel channels unless noted otherwise refer to channels extending parallel to the “z” axis. Finally the center lines of the different channels are also shown but not separately numbered.

Even though the invention is explained and illustrated with reference to the preferred structure wherein all channels and the central axis are in a single plane, the invention is not so limited and the channels may lie in different planes so long as opposing channels are in a single plane. For example, opposing diverging channels 16 and 18 may be in a first plane and opposing channels 20 and 22 may be in a different plane. In such case the interference zone described bellow will be in the same plane as the converging opposing channels and the interference angle θ, also described below, will be measured in this plane.

Preferably the device is formed as a solid state structure on a substrate. The channels are formed by local modification of the index of refraction of the substrate. This may be done through optical (or electronic) beam lithography or crystal growth in association with ion exchange processes of electro-optical crystals. Alternatively, quantum well growth (Molecular Beam Epitaxy, MBE, or metal-organic chemical vapor deposition, MOVCD) of a core and a cladding in semiconductor materials such as for example GaAs, or AlGaAs, may be used, particularly where it is desired to produce the coupler with an integrated laser radiation source at its input as shown in FIG. 2. Recently developed technology for optical writing using intense femtosecond laser beams on silica or BK7 glass for the manufacture of passive components may also be used to produce the optical or waveguide channels.

At the input end of the coupler, radiation R may be coupled in any of the known ways including another coupler designed according to the present invention. Alternatively, as shown in FIG. 2, in the particular case where the input radiation source is a solid state laser 13, the coupler 10′ is, preferably, grown integral with the laser 13 at the output of the lasing surface 15.

Input radiation at the interferometer coupler input 14 is split into two equal diverging paths 16 and 18 and then recombined at an output point 26 after traveling along converging paths 20 and 22 generating an interference pattern at the output of the coupler 10. FIG. 1B illustrates the area of beam interference at the coupler output and accordingly the optimum positioning of the input end of the single mode fiber or waveguide 12.

The optimization of energy transfer from the radiation source to the receiving element is obtained by calculating a converging angle “θ” for each of the converging channels 20 and 22 such that the primary constructive spatial interference fringe mode 34 generated at the output of the coupler has a width and shape that best matches the effective input end mode of the single mode fiber or wave guide as shown in FIG. 1A. By matching the primary interference fringe mode to the fiber mode, maximum energy transfer between the input radiation and the receiving single mode fiber is achieved.

With both converging angles θ equal, the radiation exiting both channels 20 and 22 converges on the coupler axis z forming an interference zone defined by the beam width (waist) of the two channels as shown in FIG. 1B. FIG. 1A shows the interference pattern in the x-y plane incident on the face of a single mode fiber 12 comprising a core 28 and a cladding 30 placed at the point where the center lines of the radiation beams intersect. The interference pattern comprises bright 34 and dark 32 and 32′ generally oval shaped spatial interference fringes formed by the constructive and destructive interference of radiation exiting at different angles (+ and −θ) from the coupler.

Proper selection of the optical length, of the converging radiation paths and angle θ, permits controlling the shape and location of the interference pattern to maximize energy transfer at the output of the coupler to the single mode fiber 12 by matching the interference fringe mode to the fiber mode field at a particular location along the z axis. Optical length is the product of the physical length (measured in m or inch) by the refractive index of the waveguide or channel core. When the receiving fiber is a single mode fiber what is matched is the mode field diameter (MFD) for that fiber. The use of such interference mode match permits coupling efficiencies of the order of 91%.

Selection of the interference angle θ is a function of the wavelength and spatial characteristics of the input radiation beam R and the output fiber 12. This angle is estimated from overlapping-integral calculations of the fiber optic and the incident spatial interference mode profiles and is derived by maximizing the theoretical energy transfer efficiency “η” in the constructive fringe mode that matches the fiber mode. The numerical calculations, based on the overlapping integrals shown bellow, convolute the mode profile of the fiber with the optical intensity distribution of the interference mode for different values of θ. θ is calculated by calculating ηᵢ for the interfering beams beginning with an assumed starting angle θ and varying θ to maximize the coupling efficiency η.

The diameter, 2ω_{D}, of the SMF Gaussian mode field profile (MFD) is determined empirically using Marcusse's equation relating the radius of the mode field, to the core radius of the fiber “a”, and the normalized fiber number, “V”:

$${ω}_{D} = a ( 0.65 + \frac{1.619}{{V}^{3 / 2}} + \frac{2.879}{{V}^{6}} )$$

where V is given by: V=2π.a.NA/λ and where NA is the numerical aperture of the fiber.

The coupling efficiency, η, can then be obtained by calculating the normalized integral:

$$η = \frac{{\int }_{0}^{α {ω}_{0}} {ⅇ}^{- {r}^{2} / {ω}_{D}^{2}} \cdot f ( r ) \cdot r ⅆ r}{{( {\int }_{0}^{α {ω}_{0}} {ⅇ}^{- 2 {r}^{2} / {ω}_{D}^{2}} \cdot r ⅆ r \cdot {\int }_{0}^{α {ω}_{0}} {f}^{2} ( r ) \cdot r ⅆ r )}^{0.5}}$$

where f(r) is the incident light intensity profile function and exp-(r²/ω_{D}²) is the fiber mode distribution. The estimated coupling efficiencies for the interference fringe is arrived at by using the corresponding profile functions f(r) coupled into the SMF.

Each beam propagating in each channel of the interferometer is assumed to have a Gaussian profile. The Gaussian beam profile function is determined by, (1/ωₒ).exp-(r²/ωₒ²), where ωₒ is the focused beam waist. E₁ and E₂ represent the beam optical field amplitude of the radiation emanating from each channel of the interferometer respectively, |E₁(r)+E₂(r)|² represents the interference intensity profile function, where Eᵢ(r) stands for the field amplitude of the two interfering Gaussian beams (i=1,2). Because the two beams propagate at an angle +θ and −θ respectively, Eᵢ is a function along the z axis and is a function of θ therefore ultimately η is a function of θ. (See also Optics Communications, 138 (1997) 354-364 Volume Grating Produced by Intersecting Gaussian Beams in an absorbing medium: A Bragg diffraction model by Abdulatif Y. Hamad and James P. Wickstead. For a more complete derivation of the formulae used to calculate η as a function of θ). Appendix A attached hereto shows the sequence of calculations used to derive the optimum interfering angle and may be used to develop a computer program to perform such calculation.

As shown in FIG. 1B, at the exit of the coupler according to this invention there is a zone of interference between the two beams exiting channels 20 and 22 respectively. This zone can be easily calculated from simple geometry once the beam waist (which is the substantially equal to the radius, ω_{D}, of the Gaussian mode field profile of the propagation channel at this point) and the interference angle θ are known. This calculation provides an interference zone of total length Lᵢₙₜ extending equally along axis “z” on either side of the point of intersection of the exiting beams centerline which, because θ is the same for both beams, is on axis “z”.

### EXAMPLE

Using the calculations shown in the appendix the following results are obtained for a coupler such as illustrated in FIG. 1, the length of the channels 16, 18, 20 and 22 and the diverging and converging angles β and θ for a particular type of single mode fiber, specifically a Corning SMF28. This fiber has a typical MFD=8.2 μm and a NA=0.14. For this fiber and at λ=1550 nm, V=2.33. For an input (to the fiber) beam waist ω₀=8.1 μm, V×ω₀=18.87 μm, yielding an optimum interference angle (converging angle θ) of about 2.9°.

The interference is localized where the two output beams cross as illustrated in FIG. 1B. Having determined the converging angle, simple geometrical considerations from FIG. 1B indicate that the input end of the single mode fiber 12 (in this example the input face of SMF28) may be placed anywhere between +½Lᵢₙₜ and −½Lᵢₙₜ from the crossing point, in this instance a total Lᵢₙₜ=162 μm.

Having defined the interference zone, it is noted that maximum energy transfer occurs when the input of the single mode fiber or wave guide is positioned at the Rayleigh distance from the end of the channel, as this is the highest energy concentration point (minimum waist) of the emerging radiation beam. The Rayleigh range zₒ is as shown in FIG. 1B along the propagation axis of the channel and its value equals π.(ωₒ)²/λ.

For a laser emitting at λ=1550 nm the corresponding Rayleigh range is 34.1 μm. For an optimum coupling efficiency, it is preferable, in this case, to set the input face of the output fiber within the projected Rayleigh range, zₒ.cos θ=34.02≈34 μm since it is smaller than the interference zone length Lᵢₙₜ.

L₂ is calculated as L₂=d/tan 2.9° or ≅2 mm, providing a typical lateral offset d=100 μm.

Typically, the front end parameters (L1 and β) may also be estimated using the same overlapping integrals as before. However such calculation is eliminated by the use of commonly available Mach-Zehnder interferometer technology. For a typical offset d=100 μm L1 is 20 mm and β=0.29°. (See also the following: G. Hunsperger, Photonic Devices and Systems, Ed. Marcel Dekker, Inc. (1994), pp. 346-359.) Hence in this example, the total coupler length equals 22 mm.

In practice, due to manufacturing limitations regarding the exact termination point of the two channels 20 and 22 it is preferred to position the input face of the receiving fiber or wave guide at a point on the z axis as close to the calculated distance from the end of the coupler and experimentally move the fiber or wave guide back and forth along the z axis to maximize energy transfer by matching the actual interference fringe mode to the fiber or wave guide fiber mode. Once the optimum position has been determined the fiber input face and the fiber are fixed relative to the output end of the coupler. Fixing may be by gluing, by soldering (in the case of metal coated fibers) or by a clamp 11 as shown in FIG. 2.

Returning now to FIG. 1, there is inserted in channel 17′ a delay device 36 which is used with an external electronic modulator 38 to introduce a phase delay in the radiation traveling along this path. The introduction of such delay introduces a phase shift between the radiation traveling along this path and radiation traveling along the other path and results in a lateral shifting of the interference bands in the x-y plane as shown in FIG. 3 and discussed below.

In a preferred alternative embodiment shown in FIG. 2, the converging and diverging channels are separated by two parallel channels 17 and 17′ as in a typical integrated Mach-Zehnder interferometer. Phase shifting devices 36 and 36′ may be electrodes applied to both channels and connected to the electronic modulator 38. An additional electrode 37 may be implemented in between the devices 36 and 36′ in a push pull configuration where two opposite electrical fields are applied to the two parallel channels 17 and 17′. The electronic modulator 38 applies to the central electrode 37 a combination of a DC bias voltage and an RF voltage to operate the modulator at the middle of its linear response slope. The grounding of the two external electrodes and the application of the bias voltage to a central electrode 37 create opposite effects in the two waveguide-channels. A locally applied electric field changes the local refractive index of the channel material. The variation in the refractive index results in a change in the phase of the light signal that travels along the channel. The two refractive index changes are of opposite signs and correspond ultimately to two phase shifts of opposite signs as well.

The phase shift in the recombining beams results in shifting the interference fringes laterally in the x-y plane across the input face of the receiving fiber or waveguide. Maximum energy transfer occurs when the primary constructive interference fringe spatial mode matches the input fiber mode following proper selection of the interference angle θ. As shown in FIG. 3, as a given biased voltage (DC+RF) is applied to the phase delay device the primary interference fringe 34 shifts laterally to position 34′ so that it no longer fully coincides with the input fiber mode and the energy coupled to the fiber decreases. Eventually as the RF voltage increases fringe 34 shifts to position 34″ completely outside of the fiber input so that there is zero optical field incident on the fiber input end. Thus the optical field amplitude transfer to the fiber may be varied at will from 0% to 100% providing full amplitude modulation range.

In addition, due to the matching of the primary constructive interference fringe mode to that of the fiber input mode, coupling of the modulated beam to the receiving input is highly efficient approaching 91% for the case where extinction value is 0% as explained above.

The lateral shift of the interference pattern and the constructive interference fringe 34 is linear with respect the bias voltage applied, as shown in FIG. 3 where the position of the fringe along the y-axis is shown as a function of the applied voltage. Thus, because the modulation does not rely on a change in the intensity of the primary constructive interference fringe or its mode but rather in its mode matching with the mode of the input fiber which depends on its lateral alignment with the fiber axis, the applied voltage profile needed to obtain modulation linearity reduces to mode overlapping calculations dependent on the geometry of the fiber optic mode and the degree of lateral shift of the fringe as a function of the applied voltage.

While preferred embodiments of the invention have been shown and described herein, it will be understood that such embodiments are provided by way of example only. Numerous variations, changes and substitutions will occur to those skilled in the art without departing from the spirit of the invention. Accordingly, it is intended that the appended claims cover all such variations as fall within the spirit and scope of the invention.

What is claimed

1. An integral solid state radiation coupler/modulator comprising a radiation input end and a radiation output end said radiation input end connected to said radiation output end through first and second diverging and third and fourth converging radiation paths wherein said third and fourth radiation paths converge to said output end at an angle 2θ wherein θ is an interference angle calculated to produce an exiting radiation interference pattern of radiation entering said input end at an interference zone outside said output end, wherein said radiation entering said input end has an optical field amplitude and said interference pattern has a primary constructive interference fringe adapted to maximize transfer efficiency of said optical field amplitude between said entering beam and a radiation receiver input end positioned in said interference zone by matching said primary constructive interference fringe spatial mode to said radiation receiver input end mode, the coupler/modulator further comprising a phase shifting element in at least one of said diverging or converging radiation paths and an analog modulator connected to said phase shifting element.

2. The coupler/modulator according to claim 1 wherein said radiation is optical radiation.

3. The coupler/modulator according to claim 2 wherein said converging and diverging radiation paths are solid state optical channels.

4. The coupler/modulator according to claim 1 wherein said converging and diverging radiation paths are solid state waveguides.

5. The coupler according to claim 2 wherein said radiation is emitted by a laser and said laser is integral with said coupler/modulator input end.

6. The coupler/modulator according to claim 1 further comprising two substantially parallel channels between said first and second diverging and said third and fourth converging channels respectively.

7. The coupler/modulator according to claim 6 further comprising a phase shifting element in each of said two parallel channels and a third one in between the channels and wherein said phase shifting elements are connected to said analog modulator driver in a push pull configuration.

8. A method for simultaneously modulating and coupling a radiation beam to a receptor input end, said input end comprising an input mode, the method comprising:
a. splitting said radiation beam into a first and a second substantially equal intensity beams propagating along first and second solid state equidistant diverging channels;
b. directing said split diverging beams to and along a third and a fourth also solid state equidistant converging radiation propagation channels respectively, said channels converging at an angle 2θ relative to each other, wherein said third and fourth channels terminate at an end point prior to overlapping;
c. forming an interference pattern of said converging third and fourth beams in an interference zone after exiting said third and fourth channels said pattern comprising at least one constructive interference fringe having an optical field amplitude and a spatial mode;
d. positioning said radiation receptor input end in said interference zone at a point where said constructive interference fringe mode matches said first receptor input mode; and
e. altering the optical field amplitude incident on said receptor input end by applying an analog modulating signal to shift the phase of said at least one of said beams and laterally shifting the position of said constructive interference fringe across said input end of said receptor.
